(19) United States
(12) Patent Application Publication
(10) Pub. No.: US 2021/0184415 A1
(43) Pub. Date: Jun. 17, 2021

(54) METHOD OF MANUFACTURING ELECTRICAL CONNECTOR ASSEMBLIES

(71) Applicant: Lear Corporation, Southfield, MI (US)

(72) Inventors: Marlon Christian Grosser, Remscheid (DE); Ümit Celiker, Remscheid (DE)

(73) Assignee: Lear Corporation, Southfield, MI (US)

(21) Appl. No.: 17/082,764

(22) Filed: Oct. 28, 2020

(30) Foreign Application Priority Data
Dec. 12, 2019 (DE) 102019219453.2

(51) Int. Cl. H01R 43/26; G05B 19/406

(52) U.S. Cl. CPC H01R 43/26; H01R 13/641; G05B 19/406

(57) ABSTRACT

A method of manufacturing a plurality of electrical connector assemblies includes assembling a plurality of individual electrical connector assemblies within a facility. The assembly includes a plurality of connectors. Each of the connectors includes a connector position assurance that is movable between an opened position and a closed position and an indicator that is in a concealed condition when the connector position assurance is in the opened position and in an exposed condition when the connector position assurance is in the closed position. For each of the indicators, a determination is made as to whether it is in the concealed condition or the exposed condition. A record is generated of the determinations of the concealed and exposed conditions for each of the indicators. Lastly, a report is generated of the record of the determinations of the concealed and exposed conditions for each of the indicators.

### BACKGROUND OF THE INVENTION

This invention relates in general to methods of manufacturing electrical connector assemblies. More specifically, this invention relates to an improved method of manufacturing a plurality of electrical connector assemblies that insures that all of the individual electrical connector assemblies are in a properly assembled condition before being shipped from a manufacturing facility to a customer.

Connectors are commonly used when manufacturing assemblies of electrical components. The connectors allow separate subassemblies of such electrical components to be prepared, placed onto the assembly, and connected to each other during an assembly process. For example, a typical vehicle includes a variety of electrical components, such as lights, sensors, fans, and heaters. Each of these electrical components is normally connected to a power supply and a controller by wiring located in the vehicle.

When the vehicle is being assembled, a seat subassembly can be placed on a frame during one part of the assembly process. The seat subassembly can include a plurality of electrical components, such as ventilation fans, heaters, and seat adjustment motors. The wires for the electrical components on the seat subassembly are typically grouped into a wire harness having an electrical connector attached thereto. During the assembly process, the electrical connector is mated with a corresponding connector located elsewhere on the vehicle.

A typical vehicle includes a relatively large number of such electrical connectors. For proper use of all of the electrical components, it is desirable that all the electrical connectors being manufactured and remain in a properly mated condition. However, one or more of the electrical connectors may not be properly mated because of, for example, a flaw in the electrical connector, an error occurring during the assembly process, or by being inadvertently disconnected sometime after the assembly process. Thus, it would be advantageous to provide a method that allows the status of electrical connectors to be tracked in order to identify when and electrical connector is not properly mated.

### SUMMARY OF THE INVENTION

This invention relates to a method of manufacturing a plurality of electrical connector assemblies that insures that all of the individual electrical connector assemblies are in a properly assembled condition before being shipped from a manufacturing facility to a customer. Initially, a plurality of individual electrical connector assemblies is assembled within a facility, each assembly including a plurality of connectors. Each of the connectors includes a connector position assurance that is movable between an opened position and a closed position and an indicator that is in a concealed condition when the connector position assurance is in the opened position and in an exposed condition when the connector position assurance is in the closed position. For each of the indicators, a determination is made as to whether it is in the concealed condition or the exposed condition. A record is generated of the determinations of the concealed and exposed conditions for each of the indicators. Lastly, a report is generated of the record of the determinations of the concealed and exposed conditions for each of the indicators.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an electrical connector that includes a connector position assurance shown in an opened position.

FIG. 2 is a perspective view of the electrical connector illustrated in FIG. 1 showing peak the connector position assurance in a closed position.

FIG. 3 is a schematic view of an assembly that includes the electrical connector illustrated in FIGS. 1 and 2.

FIG. 4 is a schematic view of a facility wherein the assembly from FIG. 3 is assembled.

### DETAILED DESCRIPTION OF THE PREFERRED EMBODIMENT

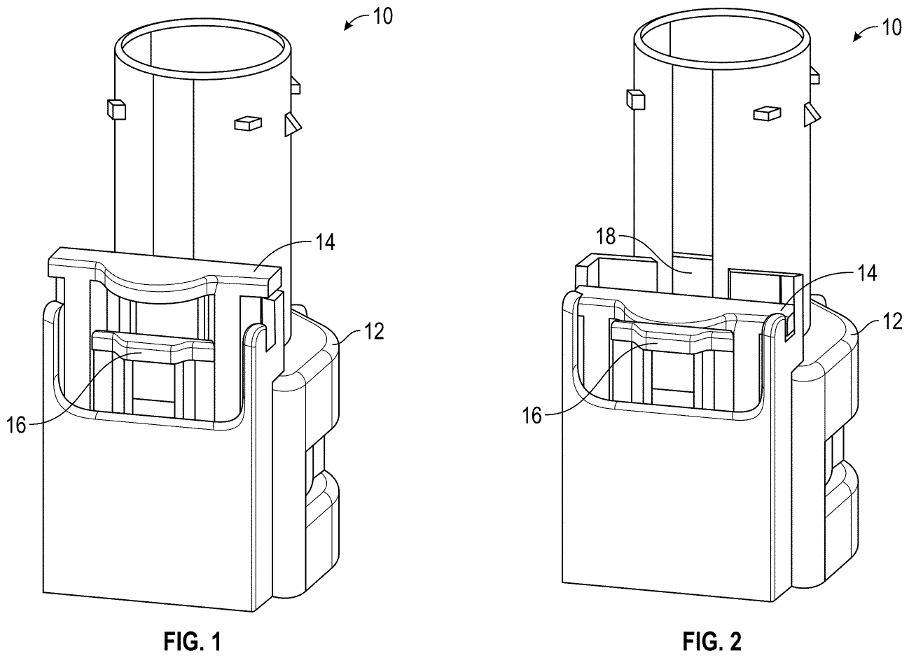

Referring now to the drawings, there is illustrated in FIG. 1 a connector, indicated generally at 10, that may be manufactured in accordance with the method of this invention. The illustrated connector 10 is an electrical connector, but may be any desired type of connector. The connector 10 includes a housing 12 and a connector position assurance 14 that is attached to the housing 12. In FIG. 1, the connector position assurance 14 is shown in an opened position. The connector position assurance 14 is movable relative to the housing 12 to a closed position, as shown in FIG. 2. The electrical connector 10 is adapted to mate with a complementary connector (not shown) and includes a latch 16 that retains the housing 12 in a mated position on the complementary connector. When the connector position assurance 14 is in the opened position, the latch 16 is operable so that the connector 10 may be released from the complementary connector. When the connector position assurance 14 is in the closed position, the latch 16 is held in place so that the electrical connector 10 cannot be released from the complementary connector. The electrical connector 10 includes many features in common with the electrical connector assembly described in U.S. Pat. No. 10,340,632, the disclosure of which is incorporated herein by reference. The illustrated electrical connector 10 is one example of a connector that the invention described herein can be used with, but the invention may be used with any desired type of connector.

In normal use, the electrical connector 10 is attached to one or more electrical wires (not shown) and electrical terminals (not shown). The connection position assurance 14 is retained in the opened position until the housing 12 is mated with the complementary connector. Once the electrical connector 10 is in a mated position relative to the complementary connector, the connector position assurance 14 may be moved to the closed position. Thus, the connector position assurance 14 provides confirmation that the electrical connector 10 is in the mated position relative to the complementary connector, and further retains the electrical connector 10 in the mated position by preventing operation of the latch 16.

As best shown in FIG. 2, the electrical connector 10 includes an indicator 18. Depending on location of connector position assurance 14 relative to the housing 12 of the electrical connector 10, the indicator 18 may be in either a concealed condition (as shown in FIG. 1) or an exposed condition (as shown in FIG. 2). When the indicator 18 is in the concealed condition, the indicator 18 cannot be detected visually or otherwise from the exterior of the electrical connector 10. When the indicator 18 is in the exposed condition, the indicator 18 can be detected visually or otherwise from the exterior of the electrical connector 10. The illustrated indicator 18 is a two-dimensional bar code that is laser printed on an exterior surface of the housing 12. However, the indicator 18 may be embodied as any desired type of marking that is provided in any desired manner and at any desired location of the housing 12. The illustrated indicator 18 is adapted to be machine-readable, as will be described in greater detail below.

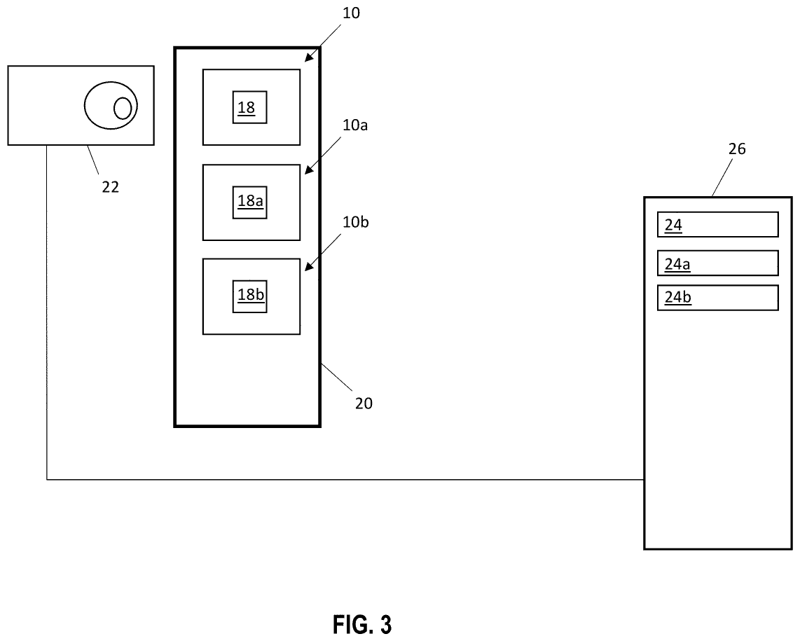

Referring now to FIG. 3, there is illustrated a schematic view of an assembly 20. The illustrated assembly 20 is a vehicle, but it may be any desired type of assembly. The assembly 20 includes not only the electrical connector 10, but additional electrical connectors 10a and 10b that may (but are not required to) be similar in structure and operation to the electrical connector 10. Each of the additional electrical connectors 10a and 10b includes a respective indicator 18a and 18b.

A machine input 22 may be used to read the indicator 18 on the electrical connector 10. The illustrated machine input 22 is an optical camera, but may be any desired device. As previously described, the indicator 18 is readable when the indicator 18 is in the exposed condition. Thus, the machine input 22 is able to read the indicator 18 only when the connector position assurance 14 is in the closed position. The same machine input 22 can also read the indicator 18a and 18b on the additional electrical connectors 10a and 10b. If desired, different machine inputs (not shown) may be used to read the indicators 18a and 18b.

The machine input 22 can read the indicator 18 any time after the indicator 18 is in the exposed condition, i.e., when the connector position assurance 14 is in the closed position. For example, an operator may mate the electrical connector 10 with the complementary connector, move the connector position assurance 14 to the closed position, and then use the machine input 22 to read the indicator 18. Alternatively, the machine input 22 may read the indicators 18, 18a, and 18b during an end-of-line review of the assembly 20. The machine input 22 may be moved into a position to read the indicators 18, 18a, and 18b manually by the operator or by a machine if desired.

When the indicator 18 is read, the machine input 22 generates a record 24 that is stored in a memory 26. The record 24 may include the identities of both the electrical connector 10 and the assembly 20. The record 24 may include any desired information, such as date, time, identity of the operator, and the like. Similarly, when the indicators 18a and 18b are read, respective records 24a and 24b are generated and stored in the memory 26.

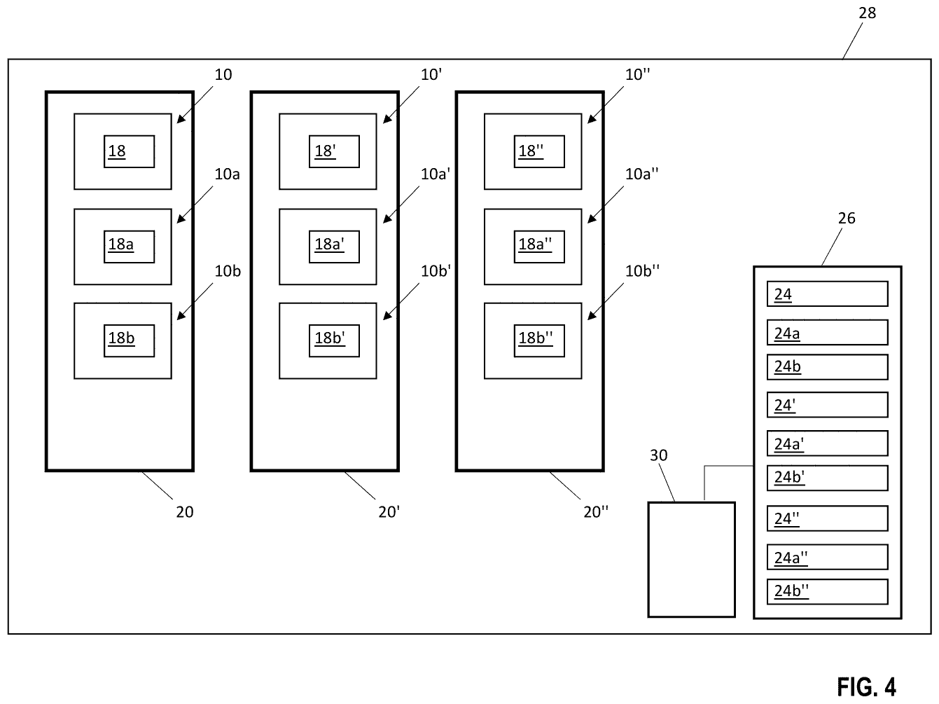

Referring to FIG. 4, there is illustrated a schematic view of a facility 28 where the assembly 20 is produced. The illustrated facility 28 is a manufacturing plant that includes an assembly line, but it may be any desired type of facility. In addition to the assembly 20, the facility 28 produces additional assemblies 20′ and 20″. The additional assemblies 20′ and 20″ are similar to the assembly 20, all of which may be manufactured using an assembly line process. The illustrated assemblies 20, 20′, and 20″ are provided only for illustrative purposes, and the facility 28 can produce any desired number of assemblies.

Each of the assemblies 20′ and 20″ includes respective electrical connectors 10′, 10a′, 10b′ and 10″, 10a″, 10b″ that are similar to the previously-described electrical connectors 10, 10a, and 10b and that include respective 18′, 18a′, 18b′ and 18″, 18a″, 18b″ that are similar to the previously-described indicators 18, 18a, and 18b. The machine input 22 is used to read each of the indicators 18′, 18a′, 18b′, 18″, 18a″, and 18b″. The single machine input 22 may be used to read all the indicators 18′, 18a′, 18b′, 18″, 18a″, and 18b″, or multiple machine inputs (not shown) may be used, if desired.

When each of the indicators 18′, 18a′, and 18b′ is read, the machine input 22 generates a respective record 24′, 24a′, and 24b′ that is stored in the memory 26. Each of the records 24′, 24a′, and 24b′ includes the identity of the assembly 20′. Similarly, when each of the indicators 18″, 18a″, and 18b″ is read, the machine input 22 generates a respective record 24″, 24a″, and 24b″ that is stored in the memory 26. Each of the records 24″, 24a″, and 24b″ includes the identity of the assembly 20″.

The records 24, 24a, and 24b that are stored in the memory 26 allow a manager of the facility 28 to track the status of the connectors 10, 10a, and 10b. This allows the manager to review the status of the assembly 20 at any desired time. For example, a report 30 may be created from the memory 26 when the assembly 20 has been assembled, but before the assembly 20 leaves the facility 28. A review may be made of the records 18, 18a, and 18b in order to confirm that the associated connector 10, 10a, and 10b is properly mated and the associated connector position assurance 14 is in the closed position. Additionally, after the assembly 20 has left the facility 28, if one or more of the connectors 10, 10a, and 10b is determined to not be properly mated or closed, the records 24, 24a, and 24b in the memory 26 may be used to confirm the state of the assembly 20 when it left the facility 28, as well as to identify when and where in the facility 28 the indicators 18, 18a, and 18b were read. This information can be used to identify a possible process error inside the facility 28 or to isolate an error to having occurred outside the facility 28.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method for tracking the status of an assembly comprising the steps of:
assembling a plurality of assemblies within a facility, wherein each assembly includes a plurality of connectors, and wherein each of the connectors includes a connector position assurance that is movable between an opened position and a closed position and an indicator that is in a concealed condition when the connector position assurance is in the opened position and in an exposed condition when the connector position assurance is in the closed position;
determining, for each of the indicators, whether it is in the concealed condition or the exposed condition;
generating a record of the determinations of the concealed and exposed conditions for each of the indicators; and
generating a report of the record of the determinations of the concealed and exposed conditions for each of the indicators.

2. The method for tracking the status of an assembly of claim 1, wherein the report is generated when the assembly is at the facility.

3. The method for tracking the status of an assembly of claim 1, wherein the report is generated when the assembly is out of the facility.

4. A system for tracking the status of an assembly, the system comprising:
a facility wherein an assembly is assembled, the assembly including a plurality of connectors, each of the connectors including a connector position assurance that is movable between an opened position and a closed position and an indication that is switchable between an inactive state when the connector position assurance is in the opened position and an active state when the connector position assurance is in the closed position;
a machine input that reads each of the indications in the active state to generate a respective record that is saved in a memory; and
a report that indicates the status of each of the indications.

5. The system for tracking the status of an assembly of claim 4, wherein the report is created when the assembly is at the facility.

6. The system for tracking the status of an assembly of claim 4, wherein the report is created when the assembly is out of the facility.

7. A method for tracking the status of an assembly comprising the steps of:
assembling an assembly that includes a plurality of connectors;
moving a connector position assurance on each of the connectors to a respective closed position so that a respective indicator is switched to an active state;
reading each of the indicators with a machine input to generate a plurality of records;
saving each of the records in a memory; and
generating a report that indicates the status of each of the indicators on the assembly.
